(19) United States
(12) Patent Application Publication
(10) Pub. No.: US 2021/0395524 A1
(43) Pub. Date: Dec. 23, 2021

(54) POLYPHENYLENE SULFIDE RESIN COMPOSITION SUITABLE FOR LASER MARKING

(71) Applicant: Toray Resin Company, Shelbyville, IN (US)

(72) Inventors: So Wakao, Shelbyville, IN (US); Kazuki Akiba, Shelbyville, IN (US)

(73) Assignee: Toray Resin Company, Shelbyville, IN (US)

(21) Appl. No.: 16/906,628

(22) Filed: Jun. 19, 2020

(51) Int. Cl. C08L 81/04

(52) U.S. Cl. CPC C08L 81/04

(57) ABSTRACT

Provided is a polyphenylene sulfide (PPS) resin composition suitable for laser marking. Properties for laser marking of the PPS resin composition are improved. The resin articles formed of the PPS resin composition, to which the bar codes and QR codes, etc. are applied, are useful for electronic equipment, automobile parts, structural parts, machine parts, and transport parts, for which traceability is needed. The PPS resin composition contains (A) a PPS resin, (B) a thermoplastic resin having a melting point of 200° C. or less, (C) a carbon black, and (D) an oxygen-deficient bismuth oxide represented by Bi₂O₍₃₋ₓ₎.

### FIELD OF THE INVENTION

The present invention relates to a polyphenylene sulfide (PPS) resin composition suitable for laser marking. The present invention significantly improves properties of polyphenylene sulfide compositions for laser marking. For example, productivity of applying laser marking to polyphenylene sulfide resin articles is improved. Further, bar codes and quick response (QR) codes can be effectively applied on the resin articles of the PPS resin composition and are clearly readable. The obtained product formed of the PPS resin composition is useful for electronic equipments, automobile parts, structural parts, machine parts, and transport parts, etc. for which traceability is needed.

### TECHNICAL BACKGROUND

In recent years, traceability of products becomes more important due to the improvement of product quality and heightened awareness of safety, and it is possible to easily manage detailed information by using QR codes and bar codes placed on the products. Compared to labels and conventional ink prints, using laser marking to print directly such codes or marks on the product allows permanent or semi-permanent reliable labeling and management without detaching or disappearing, and it is useful even in small molded products, to which it is difficult a label is attached.

Polyphenylene sulfide resin (hereinafter sometimes abbreviated as PPS resin) has excellent properties as engineering plastics such as excellent heat resistance, chemical resistance, electrical insulation, and heat and humidity resistance. Thus, it is used in a wide range of fields, especially in the electronic equipment, automotive, oil, and gas fields.

However, the laser marking properties of PPS resin is poor, and it is difficult to make small prints and detailed and stable markings, and there are issues such as restrictions on applicable product shapes and low productivity. For example, although it is proposed to employ bismuth oxide as additives to improve the laser marking properties of PPS resin (e.g., U.S. Pat. No. 5,668,214), such a PPS resin composition needs more improvements and has some technical issues to be resolved.

### SUMMARY OF INVENTION

The present invention significantly improves the laser marking properties of the polyphenylene sulfide resin compositions such as a marking speed, and the readability of barcodes, QR codes, and the like. Laser marking can be applied to a wide range of fields such as electronic devices, automobiles parts, structural parts, machine parts, and transportation parts, which requires traceability of products, in accordance with the present invention. For instance, the present application includes at least the following inventions.
1. A polyphenylene sulfide resin composition comprising:
(A) a polyphenylene sulfide resin;
(B) a thermoplastic resin having a melting point of 200° C. or less in accordance with ISO 11357 in an amount of 0.5 to 4.0 parts by weight based on 100 parts by weight of the polyphenylene sulfide resin (A);
(C) a carbon black in an amount of 0.5 to 1.8 parts by weight based on 100 parts by weight of the polyphenylene sulfide resin (A); and
(D) oxygen-deficient bismuth oxide represented by the following formula in an amount of 0.15 to 0.55 parts by weight based on 100 parts by weight of the polyphenylene sulfide resin (A):

Bi₂O₍₃₋ₓ₎,
wherein x is 0.01≤x≤0.3 and represents the amount of oxygen vacancy by the following formula (1):

x=3−(O1s/Bi4f)×2 (1)
wherein O1s represents an area of a peak attributed to 1s electron of oxygen bound to bismuth and Bi4f represents an area of a peak attributed to 4f electrons of bismuth obtained by X-ray photoelectron spectroscopy, respectively, and (O1s/Bi4f) represents a ratio of the area of O1s to the area of Bi4f.
2. The polyphenylene sulfide resin composition according to above invention 1, wherein (B) the thermoplastic resin comprises at least one resin selected from the group consisting of a polyester resin, a polyamide resin, and a polycarbonate resin.
3. The polyphenylene sulfide resin composition according to any of the above, wherein (B) the thermoplastic resin is a polyamide resin.
4. The polyphenylene sulfide resin composition according to any of the above, wherein the amount of the carbon black (C) is 0.7 to 1.2 parts by weight based on 100 parts by weigh of the polyphenylene sulfide resin (A).
5. The polyphenylene sulfide resin composition according to any of the above, further comprising (E) an inorganic filler in an amount of 10 to 150 parts by weight based on 100 parts by weight of the polyphenylene sulfide resin (A).
6. The polyphenylene sulfide resin composition according to above invention 5, wherein the inorganic filler (E) is a glass fiber.

By utilizing the present invention, the laser marking properties of the polyphenylene sulfide resin composition are significantly improved. In addition to the improvement of the marking speed, by improving the readability of barcodes, QR codes, etc., the polyphenylene sulfide resin composition can be used in a wide range of fields such as electronic equipment, automobile parts, structural parts, machine parts, and transportation parts, which require traceability of such products.

### DETAILED DESCRIPTION OF THE INVENTION

The polyphenylene sulfide resin composition contains (A) a polyphenylene sulfide resin; (B) a thermoplastic resin having a melting point of 200° C. or less in accordance with ISO 11357; (C) a carbon black; and (D) oxygen-deficient bismuth oxide represented by the following formula:

Bi₂O₍₃₋ₓ₎,

where x is 0.01≤x≤0.3 and represents the amount of oxygen vacancy defined by the following formula (1):

x=3−(O1s/Bi4f)×2 (1)

where O1s represents an area of a peak attributed to is electron of oxygen bound to bismuth and Bi4f represents an area of a peak attributed to 4f electrons of bismuth obtained by X-ray photoelectron spectroscopy, respectively, and (O1s/Bi4f) represents a ratio of the area of O1s to the area of Bi4f.

(A) Polyphenylene Sulfide

PPS resin (A) used in the present invention is a polymer having a repeating unit represented by the following structural formula (I):

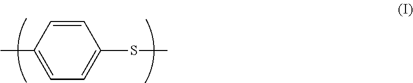

From the viewpoint of heat resistance, a polymer containing 70 mol % or more, more preferably 90 mol % or more of a polymer containing a repeating unit represented by the above structural formula (I) is preferred. Moreover, less than 30 mol % of the repeating units of the PPS resin may be composed of repeating units having the following structures:

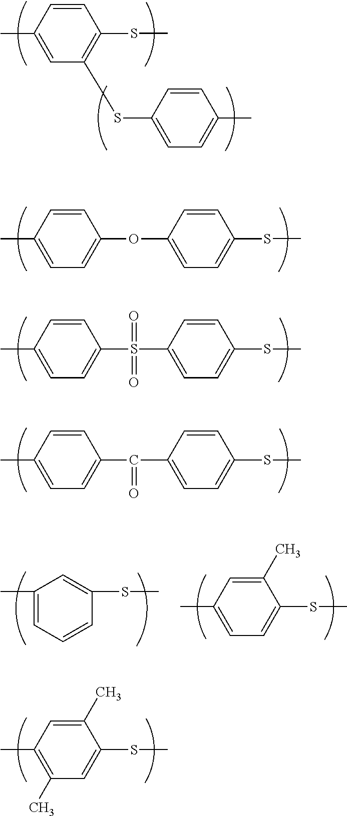

Since in a PPS resin, the smaller the amount of chloroform that is extracted, the smaller the oligomer component, which lowers the chlorine content. Therefore, the amount of chloroform extracted from the (A) PPS resin used in the present invention is preferably 0.5% by weight or less for obtaining a low-salt resin composition, and further preferably 0.4% by weight or less.

When the amount of chloroform extracted from the PPS resin exceeds 0.5% by weight, the amount of chloroform extracted from the resin composition using the PPS resin is undesirably large. In the present invention, as a method for reducing the amount of chloroform extracted, in which a polymerization step and a post-treatment step are combined, is preferably used as described herein later. The chloroform extraction of (A) PPS resin in the present invention is performed with a Soxhlet extractor, by freeze-pulverizing the PPS resin, extracting the chloroform for 5 hours with 32 mesh pass, 2.0 gram of mesh particles of 42 mesh-on, and 200 ml of chloroform, then drying the extract at 50° C. The chloroform extraction amount is represented in percentage of the weight of the residue of the extract divided by the amount of the PPS resin sample used.

The melt viscosity of the (A) PPS resin used in the present invention is preferably in the range of 5 to 50 Pa·s (310° C., shear rate 1,216/s) from the viewpoint of obtaining a resin composition having excellent melt fluidity, and the range of 10 to 45 Pa·s is more preferable, and the range of 10 to 40 Pa·s is further more preferable. Two or more polyphenylene sulfide resins having different melt viscosities may be used in combination. The melt viscosity of the (A) PPS resin in the present invention is a value measured using a CAPILOGRAPH® manufactured by Toyo Seiki Co. under conditions of 310° C. and a shear rate of 1,216/s.

A manufacturing method of (A) PPS resin used for this invention is demonstrated below, if the PPS resin which has the structure and characteristic described above is obtained, it will not be limited to the following method. However, a method in which dichlorobenzene and a sulfur source are the main monomers (90 mol % or more) and polymerization is carried out in the presence of an aprotic polar solvent is most preferable in terms of production stability.

Next, the contents of the polyhalogenated aromatic compound, sulfidizing agent, polymerization solvent, molecular weight regulator, polymerization aid, and polymerization stabilizer used in the production will be described.

Polyhalogenated Aromatic Compounds

The polyhalogenated aromatic compound (PHA) used in the present invention refers to a compound having two or more halogen atoms in one molecule. Specific examples include polyhalogenated aromatics such as p-dichlorobenzene, m-dichlorobenzene, o-dichlorobenzene, 1,3,5-trichlorobenzene, 1,2,4-trichlorobenzene, 1,2,4,5-tetrachlorobenzene, hexachlorobenzene, 2,5-dichlorotoluene, 2,5-dichloro-p-xylene, 1,4-dibromobenzene, 1,4-diiodobenzene, and 1-methoxy-2,5-dichlorobenzene. Preferably, polychlorobenzene such as p-dichlorobenzene, m-dichlorobenzene, o-dichlorobenzene, 1,3,5-trichlorobenzene, 1,2,4-trichlorobenzene, and 1,2,4,5-tetrachlorobenzene is used. Among them, p-dichlorobenzene is particularly preferably used. It is also possible to combine two or more different polyhalogenated aromatic compounds into a copolymer, but a p-dihalogenated aromatic compound represented by p-dichlorobenzene is preferably used as a main component.

The polyhalogenated aromatic compound is used in an amount of 0.8 to 1.023 mol, preferably 0.8 to 1.020 mol, per 1 mol of the sulfidizing agent from the viewpoint of obtaining a PPS resin having a viscosity suitable for processing and low oligomer elution. Further, in the sense of achieving both a degree of polymerization useful for the present invention and low oligomer properties, a range of 0.9 to 1.015 mol is useful. In the case of the above range, a PPS resin in which the above-described chloroform extraction amount is in a preferable range can be obtained.

### Sulfidizing Agent

A sulfidizing agent used in the present invention include alkali metal sulfides, alkali metal hydrosulfides, and hydrogen sulfide, for example.

Specific examples of the alkali metal sulfide include, for example, lithium sulfide, sodium sulfide, potassium sulfide, rubidium sulfide, cesium sulfide, and a mixture of two or more of these. Sodium sulfide is preferably used. These alkali metal sulfides can be used as hydrates or aqueous mixtures, or in the form of anhydrides.

Specific examples of the alkali metal hydrosulfide include, for example, sodium hydrosulfide, potassium hydrosulfide, lithium hydrosulfide, rubidium hydrosulfide, cesium hydrosulfide, and a mixture of two or more of these. Among these, sodium hydrosulfide is preferably used. These alkali metal hydrosulfides can be used as hydrates, aqueous mixtures, or in the form of anhydrides.

In addition, an alkali metal sulfide prepared in situ in a reaction system from an alkali metal hydrosulfide and an alkali metal hydroxide can also be used. Moreover, an alkali metal sulfide can be prepared from an alkali metal hydrosulfide and an alkali metal hydroxide, and transferred to a polymerization tank for use.

Alternatively, an alkali metal sulfide prepared in situ in a reaction system from hydrogen sulfide and an alkali metal hydroxide, such as lithium hydroxide or sodium hydroxide, can also be used. Moreover, an alkali metal sulfide can be prepared from hydrogen sulfide and an alkali metal hydroxide, such as lithium hydroxide or sodium hydroxide, and transferred to a polymerization tank for use.

In the present invention, the amount of the sulfidizing agent charged means the remaining amount obtained by subtracting the loss from the actual charged amount when a partial loss of the sulfidizing agent occurs before the start of the polymerization reaction due to the dehydration operation or the like.

An alkali metal hydroxide and/or an alkaline earth metal hydroxide can be used in combination with the sulfidizing agent. Specific examples of the alkali metal hydroxide include, for example, sodium hydroxide, potassium hydroxide, lithium hydroxide, rubidium hydroxide, cesium hydroxide, and a mixture of two or more thereof. Specific examples of the alkaline earth metal hydroxide include, for example, calcium hydroxide, strontium hydroxide, and barium hydroxide. Among these sodium hydroxide is preferably used.

When an alkali metal hydrosulfide is used as the sulfidizing agent, it is particularly preferable to use an alkali metal hydroxide at the same time, but the amount used is 0.90 to 1.10 mol, preferably 0.90 to 1.05 mol, and more preferably 0.95 to 1.02 mol, per 1 mol of alkali metal hydrosulfide, can be exemplified.

### Polymerization Solvent

In the present invention, an organic polar solvent is used as a polymerization solvent. Specific examples include an aprotic organic solvent represented by N-alkylpyrrolidones such as N-methyl-2-pyrrolidone and N-ethyl-2-pyrrolidone, caprolactams such as N-methyl-ε-caprolactam, 1,3-dimethyl-2-imidazolide, N,N-dimethylacetamide, N,N-dimethylformamide, hexamethylphosphoric triamide, dimethyl sulfone, tetramethylene sulfoxide, and the like, and mixtures thereof.

These are preferably used because of their high reaction stability. Among these, N-methyl-2-pyrrolidone (hereinafter sometimes abbreviated as NMP) is particularly preferred.

The amount of the organic polar solvent used is selected in the range of 2.0 to 10 mol, preferably 2.25 to 6.0 mol, more preferably 2.5 to 5.5 mol, per 1 mol of the sulfidizing agent.

Molecular Weight Regulator

In the present invention, a monohalogenated compound (which may not necessarily be an aromatic compound) may be used in combination with the polyhalogenated aromatic compound described herein in order to form a terminal end of the PPS resin to be formed or to adjust a polymerization reaction or a molecular weight of the PPS resin.

Examples of the monohalogenated compound as the molecular weight regulator (or to adjust the polymerization reaction) include monohalogenated benzene, monohalogenated naphthalene, monohalogenated anthracene, monohalogenated compound containing 2 or more benzene rings, monohalogenated heterocyclic compound, and the like. Among them, monohalogenated benzene is preferable from the viewpoint of economy. Specifically, 2-chlorobenzoic acid, 3-chlorobenzoic acid, 4-chlorobenzoic acid, sodium 4-chlorophthalate, 2-amino-4-chlorobenzoic acid, 4-chloro-3-nitrobenzoic acid, and 4′-chlorobenzophenone-2-carboxylic acid can be used.

In view of reactivity during polymerization and versatility, 3-chlorobenzoic acid, 4-chlorobenzoic acid, and sodium 4-chlorophthalate are preferred. In addition, the monohalogenated compound can also be used for the purpose of adjusting the molecular weight of the PPS resin or for reducing the chlorine content of the PPS resin.

When the carboxyl group-containing monohalogenated compound is used, it contributes not only to an increase in the carboxyl group content, but also to a reduction in the chlorine content of the PPS resin.

### Polymerization Aid

In the present invention, it is also a preferred embodiment to use a polymerization aid for adjusting the degree of polymerization. Here, the polymerization aid means a substance having an action of increasing the viscosity of the obtained PPS resin. Specific examples of such polymerization aids include, for example, alkali metal carboxylate, organic carboxylates, water, alkali metal chlorides, organic sulfonates, alkali metal sulfates, alkaline earth metal oxides, alkali metal phosphates, alkaline earth metal phosphates, and the like. These may be used alone or in combination of two or more. Among these, organic carboxylates, water, and alkali metal chlorides are preferable, and sodium and lithium carboxylates and/or water are particularly preferably used.

The alkali metal carboxylate described above is a compound represented by a general formula R(COOM)ₙ, wherein R is an alkyl group, cycloalkyl group, aryl group, alkylaryl group or arylalkyl group having 1 to 20 carbon atoms; M is an alkali metal selected from lithium, sodium, potassium, rubidium and cesium; and n is an integer of 1 to 3. Alkali metal carboxylates can also be used as hydrates, anhydrides, or aqueous solutions. Specific examples of the alkali metal carboxylate include, for example, lithium acetate, sodium acetate, potassium acetate, sodium propionate, lithium valerate, sodium benzoate, sodium phenylacetate, potassium p-toluate, and mixtures thereof.

The alkali metal carboxylate can be obtained by reaction of approximately equal chemical equivalents of an organic acid and one or more compounds selected from the group consisting of alkali metal hydroxides, alkali metal carbonates, and alkali metal bicarbonates. Among the alkali metal carboxylates described herein, lithium salts are highly soluble in the reaction system and have a large auxiliary effect, but are expensive, and potassium, rubidium and cesium salts are insufficiently soluble in the reaction system. Therefore, sodium acetate, which is inexpensive and has an appropriate solubility in the polymerization system, is preferably used.

When using these alkali metal carboxylates as polymerization aids, the amount used is usually from 0.01 to 2 mol per 1 mol of the charged sulfidizing agent from the viewpoint of obtaining a PPS resin having a viscosity suitable for processing and oligomer low elution. In the range of 0.010 to 0.088 mol is preferable from the viewpoint of achieving both the degree of polymerization useful for the present invention and low oligomer property. In the case the above range is used, a PPS resin having the above-described melt viscosity in a preferable range can be obtained.

In addition, when water is used as a polymerization aid, the addition amount is usually in the range of 0.3 mol to 15 mol per 1 mol of the charged sulfidizing agent, and in the sense of obtaining a higher degree of polymerization, 0.6 to 10 mol is preferable, and the range of 1 to 5 mol is more preferable. Of course, two or more kinds of these polymerization aids can be used in combination. For example, when an alkali metal carboxylate and water are used in combination, a higher molecular weight can be obtained in a smaller amount than when each is used alone.

There is no particular designation as to the timing of addition of these polymerization aids, which may be added at any time during a pre-process, at a polymerization start, or during a polymerization which will be described later, or may be added in multiple times. When using an alkali metal carboxylate as a polymerization aid, it is more preferable to add it at a start of the pre-process or at a start of the polymerization from the viewpoint of easy addition. When water is used as a polymerization aid, it is effective to add the water during the polymerization after the polyhalogenated aromatic compound is charged.

### Polymerization Stabilizer

In the present invention, a polymerization stabilizer may be used to stabilize the polymerization reaction system and prevent side reactions. The polymerization stabilizer contributes to stabilization of the polymerization reaction system and suppresses undesirable side reactions. One measure of the side reaction is the generation of thiophenol, and the addition of a polymerization stabilizer can suppress the generation of thiophenol. Specific examples of the polymerization stabilizer include compounds such as alkali metal hydroxides, alkali metal carbonates, alkaline earth metal hydroxides, and alkaline earth metal carbonates. Among these, alkali metal hydroxides, such as sodium hydroxide, potassium hydroxide, and lithium hydroxide, are preferred.

Since the alkali metal carboxylate described herein also acts as a polymerization stabilizer, it may be one of the polymerization stabilizers used in the present invention. In addition, when an alkali metal hydrosulfide is used as a sulfidizing agent as described herein, that it is particularly preferable to use an alkali metal hydroxide at the same time. Alkali metal hydroxides in excess relative to the sulfidizing agent can also serve as a polymerization stabilizer.

These polymerization stabilizers can be used alone or in combination of two or more. The polymerization stabilizer is preferably used with an amount of usually 0.02 to 0.2 mol, preferably 0.03 to 0.1 mol, and more preferably 0.04 to 0.09 mol, in proportion relative to 1 mol of the charged sulfidizing agent. If this proportion is too small, the stabilizing effect is insufficient conversely, if the proportion is too large, it is economically disadvantageous or the polymer yield tends to decrease.

There is no particular designation as to the timing of addition of these polymerization stabilizers, which may be added at any time during a pre-process, at a polymerization start, or during a polymerization, or may be added in multiple times. It is more preferable to add at the start of the pre-process or at the start of polymerization from the viewpoint of easy addition.

Next, the production method of the (A) PPS resin used in the present invention will be specifically described in the order of the pre-process, polymerization reaction process, recovery process, and post-treatment process.

### Pre-Process

In the method for producing the (A) PPS resin used in the present invention, the sulfidizing agent is usually used in the form of a hydrate. It is preferable to raise the temperature of the mixture including an organic polar solvent and the sulfidizing agent and to remove an excessive amount of water out of the system before adding the polyhalogenated aromatic compound.

As described above, a sulfidizing agent prepared from an alkali metal hydrosulfide and an alkali metal hydroxide in situ in the reaction system, or in a tank different from the polymerization tank is also used as the sulfidizing agent.

Although there is no particular limitation on this method, desirably an alkali metal hydrosulfide and an alkali metal hydroxide are added to the organic polar solvent in an inert gas atmosphere at a temperature ranging from room temperature to 150° C., preferably from room temperature to 100° C., then, the water is distilled away by raising the temperature to at least 150° C. or more, preferably 180 to 260° C. under normal or reduced pressure. Polymerization aids can be added at this stage. In addition, toluene, etc., can be added for the reaction to accelerate the distillation of the water.

The amount of water in the polymerization system in the polymerization reaction is preferably 0.3 to 10.0 moles per 1 mole of the sulfidizing agent charged. Here, the amount of water in the polymerization system is an amount obtained by subtracting the amount of water removed out of the polymerization system from the amount of water charged in the polymerization system. In addition, the water to be charged may be in any form such as water, an aqueous solution, and crystal water.

### Polymerization Reaction Step

In the present invention, a PPS resin is produced by reacting a sulfidizing agent and a polyhalogenated aromatic compound in an organic polar solvent within a temperature range of 200° C. or higher and lower than 290° C. When starting the polymerization reaction step, the organic polar solvent, the sulfidizing agent and the polyhalogenated aromatic compound are mixed desirably in an inert gas atmosphere at a temperature between room temperature to 240° C., preferably in the range between 100 to 230° C. A polymerization aid may be added at this stage. The order in which these raw materials are charged may be random or may be simultaneous.

Such a mixture is usually heated to a temperature in the range of 200° C. to 290° C. Although there are no particular limitations on the rate of temperature increase, a rate of 0.01 to 5° C./min is usually selected, and a range of 0.1 to 3° C./min is more preferable. In general, the temperature is finally raised to a temperature between 250 and 290° C., and the reaction is usually carried out at that temperature for 0.25 to 50 hours, preferably 0.5 to 20 hours. In the stage before reaching the final temperature, for example, a method of reacting at a temperature between 200° C. and 260° C. for a certain amount of time and then raising the temperature to between 270° C. and 290° C., is effective in obtaining a higher degree of polymerization. In this case, the reaction time at the temperature between 200° C. and 260° C. is usually selected in the range of 0.25 to 20 hours, preferably in the range of 0.25 to 10 hours. Other times, such as 0.5, 1, 5, etc. hours are contemplated.

In order to obtain a polymer having a higher degree of polymerization, it may be effective to perform polymerization in multiple stages. When the polymerization is performed in a plurality of stages, it is effective to advance to the next stage when the conversion of the polyhalogenated aromatic compound in the system at 245° C. reaches 40 mol % or more, preferably 50 mol % or more, and more preferably 60 mol %.

Further, the conversion rate of the polyhalogenated aromatic compound is a value calculated by the following formula. The residual amount of PHA can usually be determined by gas chromatography.

(a) When polyhalogenated aromatic compound is excessively added at a molar ratio to the alkali metal sulfide:

Conversion rate=[PHA charged (mol)−PHA residual amount (mol)]/[PHA charged (mol)−PHA excess amount (mol)].

(b) In cases other than (a) above:

Conversion rate=[PHA charged (mole)−PHA residual amount (mole)]/[PHA charged (mole)].

### Recovery Process

In the method for producing the (A) PPS resin used in the present invention, a solid material is recovered from a polymerization reaction product containing a polymer, a solvent and the like after the completion of polymerization. Any known recovery method may be adopted for the PPS resin used in the present invention.

For example, after completion of the polymerization reaction, a method of slowly cooling and recovering the particulate polymer may be used. The slow cooling rate at this time is not particularly limited, but is usually about 0.1° C./min to 3° C./min. There is no need for slow cooling to be at the same rate in the whole process of the slow cooling step, and a method of slow cooling at a rate of 0.1 to 1° C./min until the polymer particles crystallize and then at a rate of 1° C./min or more, may be adopted. When the above recovery method is used, a PPS resin in which the above-described chloroform extraction amount is in a preferable range can be obtained.

Moreover, it is also one of the preferable methods to perform said recovery under quenching conditions. A Flash method is one of the preferable methods of this recovery method. The Flash method is a method in which a polymerization reaction product is flashed from a high-temperature and high-pressure state (normally 250° C. or higher, 8 kg/cm′ or higher) into an atmosphere of normal pressure or reduced pressure, and the polymer is recovered in powder form simultaneously with solvent recovery. In this case, the flash means that the polymerization reaction product is ejected from a nozzle. Specific examples of the atmosphere to be flashed include nitrogen or water vapor at normal pressure, and the temperature is usually selected from the range of 150° C. to 250° C.

Among them, in order to develop a more excellent low oligomer property, a method of slowly cooling after the completion of the polymerization reaction and recovering the particulate polymer is preferably used in order to increase the cleaning effect with the organic solvent described later.

### Post-Processing Process

The (A) PPS resin used in the present invention may be produced through the above polymerization and recovery steps and then subjected to acid treatment, hot water treatment or washing with an organic solvent.

When acid treatment is performed, it is as follows. The acid used for the acid treatment of the PPS resin in the present invention is not particularly limited as long as it does not have an action of decomposing the PPS resin, and examples thereof include acetic acid, hydrochloric acid, sulfuric acid, phosphoric acid, silicic acid, carbonic acid, and propyl acid. Of these, acetic acid and hydrochloric acid are more preferably used, but those that decompose and deteriorate the PPS resin such as nitric acid are not preferable.

As the acid treatment method, there is a method of immersing the PPS resin in an acid or an acidic aqueous solution, and it is possible to appropriately stir or heat as necessary. For example, when acetic acid is used, a sufficient effect can be obtained by immersing the PPS resin powder in an aqueous pH 4 solution heated to between 80 and 200° C. and stirring for 30 minutes. The pH after the treatment may be 4 or more, for example, about pH 4-8. The acid-treated PPS resin is preferably washed several times with water or warm water in order to remove residual acid or salt. The water used for washing is preferably distilled water or deionized water in the sense that the effect of the preferred chemical modification of the PPS resin by acid treatment is not impaired.

When performing hot water treatment, it is as follows. In the hot water treatment of the PPS resin used in the present invention, the temperature of the hot water is preferably 100° C. or higher, more preferably 120° C. or higher, further preferably 150° C. or higher, and particularly preferably 170° C. or higher. Less than 100° C. is not preferable because the effect of preferable chemical modification of the PPS resin is small.

The water used is preferably distilled water or deionized water in order to express the preferable chemical modification effect of the PPS resin by the hot water washing according to the present invention. There is no particular limitation on the operation of the hot water treatment, and a predetermined amount of PPS resin is put into a predetermined amount of water and heated and stirred in a pressure vessel, or a continuous hot water treatment is performed. The ratio of water is preferably higher than that of the PPS resin, but usually a bath ratio of 200 g or less of PPS resin is selected for 1 liter of water.

Further, since the decomposition of the terminal group is not preferable, the treatment atmosphere is preferably an inert atmosphere in order to avoid decomposition of the terminal group. Further, the PPS resin after the hot water treatment operation is preferably washed several times with warm water in order to remove remaining components.

The organic solvent used for washing the PPS resin in the present invention is not particularly limited as long as it does not have a function of decomposing the PPS resin.

For example, polar solvents containing nitrogen such as N-methyl-2-pyrrolidone, dimethylformamide, dimethylacetamide,1,3-dimethylimidazolidinone, hexamethylphosphoramide, and piperazinones; sulfoxide-sulfone series solvents such as dimethyl sulfoxide, dimethyl sulfone, and sulfolane;

ketone series solvents such as acetone, methyl ethyl ketone, diethyl ketone, and acetophenone; ether series solvents such as dimethyl ether, dipropyl ether, dioxane, and tetrahydrofuran; halogen series solvents such as chloroform, methylene chloride, trichloroethylene, ethylene dichloride, perchlorethylene, monochloroethane, dichloroethane, tetrachloroethane, perchlorethane, and chlorobenzene; and aromatic hydrocarbon series solvents such as benzene, toluene and xylene, can be used.

Among these organic solvents, the use of NMP, acetone, dimethylformamide, chloroform and the like is preferable, and the use of N-methyl-2-pyrrolidone is particularly preferable in terms of obtaining an excellent oligomer removal effect. These organic solvents are used alone or in combination of two or more.

As a method of washing with an organic solvent, there is a method of immersing a PPS resin in an organic solvent, and if necessary, stirring or heating can be appropriately performed. There is no particular limitation on the washing temperature when washing the PPS resin with organic solvents, and any temperature from room temperature to about 300° C. can be selected. The higher the washing temperature, the higher the washing efficiency tends to be. However, a sufficient effect is usually obtained at a washing temperature of room temperature to 150° C. It is also possible to wash under pressure in a pressure vessel at a temperature above the boiling point of the organic solvent.

There is no particular limitation on the washing time. Depending on the washing conditions, in the case of batch-type washing, a sufficient effect can be obtained usually by washing for 5 minutes or more. It is also possible to wash in a continuous manner. Such washing with organic solvents is a process suitable for the production of the (A) PPS resin used in the present invention because a high oligomer removal effect is obtained.

In the present invention, the polyphenylene sulfide resin obtained as described above may be treated by washing with water containing an alkaline earth metal salt. The following method can be illustrated as a specific method when the polyphenylene sulfide resin is washed with water containing an alkaline earth metal salt. There are no particular limitations on the type of alkaline earth metal salt, but alkaline earth metal salts of water-soluble organic carboxylic acids such as calcium acetate and magnesium acetate are preferable examples, and alkaline earth metal salts of water-soluble organic carboxylic acids such as calcium acetate and magnesium acetate are particularly preferable.

The temperature of water is preferably room temperature to 200° C., more preferably 50 to 90° C. The amount of the alkaline earth metal salt used in the water is preferably 0.1 to 50 g, more preferably 0.5 to 30 g, for 1 kg of the dried polyphenylene sulfide resin. The washing time is preferably 0.5 hours or longer, and more preferably 1.0 hour or longer. The preferred washing bath ratio (weight of warm water containing alkaline earth metal salt per unit weight of dry polyphenylene sulfide resin) depends on the washing time and temperature, but it is preferable to wash using preferably 5 kg or more, or more preferably 10 kg or more of warm water containing alkaline earth metal per 1 kg of dry polyphenylene sulfide.

There is no limitation in particular as an upper limit and it can be high as to the amount of warm water containing alkaline earth metal, it is preferable that it is 100 kg or less from the point of the usage-amount and the effect acquired. Such warm water washing may be performed a plurality of times.

The (A) PPS resin used in the present invention can also be used after having been polymerized by heating in an oxygen atmosphere and a thermal oxidation crosslinking treatment by heating with addition of a crosslinking agent such as peroxide.

In the case of dry heat treatment for the purpose of increasing the molecular weight by thermal oxidation crosslinking, the temperature is preferably in the range of 160 to 260° C., more preferably 170 to 250° C. The oxygen concentration during treatment is preferably 5% by volume or more, more preferably 8% by volume or more.

Although there is no limitation in particular in the upper limit of oxygen concentration, about 50 volume % may be a limit. The treatment time is preferably 0.5 to 100 hours, more preferably 1 to 50 hours, and further preferably 2 to 25 hours. The heat treatment apparatus may be a normal hot air drier or a heating apparatus with a rotary or stirring blade. But in order to process efficiently and more uniformly, it is more preferable to use a heating apparatus with a rotary type or a stirring blade.

However, from the viewpoint of achieving both low oligomer elution and excellent melt fluidity, the introduction of a cross-linked structure is less preferred, and a linear PPS is preferred.

Further, dry heat treatment can be performed for the purpose of suppressing thermal oxidative cross-linking and removing volatile matter. The temperature is preferably in the range of 130 to 250° C., more preferably 160 to 250° C. In this case, the oxygen concentration is preferably less than 5% by volume, and more preferably less than 2% by volume.

The treatment time is preferably 0.5 to 50 hours, more preferably 1 to 20 hours, and even more preferably 1 to 10 hours. The heat treatment apparatus may be a normal hot air drier or a heating apparatus with a rotary or stirring blade but in order to process efficiently and more uniformly, it is more preferable to use a heating apparatus with a rotary type or a stirring blade.

In the present invention, the use of a PPS resin in which the ash content of the PPS resin is reduced to 0.2% by weight or less by deionization treatment or the like is preferable in terms that the resin composition containing the PPS resin has better toughness and molding processability. Specific examples of such deionization treatment include acid aqueous solution washing treatment, hot water washing treatment, and organic solvent washing treatment, and these treatments may be used in combination of two or more methods.

In addition, the following methods are mentioned here for the measurement of the amount of ash. About 5 g of dry PPS bulk powder is weighed into a platinum crucible and baked until it becomes a black lump on an electric stove. Next, the firing is continued in the electric furnace set at 550° C. until the carbide is completely fired. Thereafter, after cooling in a desiccator, the weight is measured, and the ash content can be calculated from the comparison with the initial weight. The lower limit of the ash content of the PPS resin is ideally 0, but a PPS resin having an ash content of 0.1% by weight or more can be preferably used.

For example, by adopting the production method as described above, it is possible to obtain (A) PPS resin having excellent low oligomer dissolution property and melt fluidity, which can thus be used for the various applications mentioned herein.

(B) Thermoplastic resin having a melting point of 200° C. or less in accordance with ISO 11357 In this invention, as (B) the thermoplastic resin having a melting point of 200° C. or less in accordance with ISO 11357, for example, polyolefin, polyvinyl chloride, polyvinylidene chloride, polystyrene, polyvinyl acetate, polytetrafluoroethylene, acrylonitrile butadiene styrene, polyacryl methacrylate, polyamide, polyacetal, polycarbonate, polybutylene terephthalate, polyethylene terephthalate, mixtures thereof, and copolymer resins thereof can be used. Among them, as the thermoplastic resin having a melting point of 200° C. or less in accordance with ISO 11357, polyamide such as nylon 6, nylon 66, nylon 11, nylon 12, nylon 612, nylon 610, mixtures thereof, and copolymer resins thereof, is preferably usable in this invention.

An amount of the thermoplastic resin (B) to be added is 0.4 to 4.0 parts by weight based on 100 parts by weight of the polyphenylene sulfide resin (A). When the amount of the thermoplastic resin (B) is less than 0.4 parts by weight, the laser marking property is not effectively enhanced. The amount of the thermoplastic resin (B) is preferably 1.0 parts by weight or more and still preferably 1.5 parts by weight or more based on 100 parts by weight of the polyphenylene sulfide resin (A). When the amount of the thermoplastic resin (B) is more than 4.0 parts by weight, an amount of gas generated increases at forming or processing the resin composition and the laser marking property is not effectively enhanced. The amount of the thermoplastic resin (B) is preferably 3.0 parts by weight or less and more preferably 2.5 parts by weight or less based on 100 parts by weight of the polyphenylene sulfide resin (A).

(C) Carbon Black

As the carbon black (C) used in the present invention, for example, furnace black, acetylene black, thermal black, and channel black can be used. Such carbon black may be used alone or two or more in combination. Further, as useful carbon black, the particle size is preferably 500 nm or less, more preferably 300 nm or less from the viewpoint of improvement of the electrical conductivity. Here, the particle diameter is an arithmetic mean diameter obtained by observing with an electron microscope.

An amount of the carbon black (C) to be added is preferably 0.5 to 1.8 parts by weight based on 100 parts by weight of the polyphenylene sulfide resin (A). When the amount of the carbon black (C) is less than 0.5 parts by weight, the laser marking property is not effectively enhanced. The amount of the carbon black (C) is more preferably 0.6 parts or more by weight, and further preferably 0.7 parts by weight or more based on 100 parts by weight of the polyphenylene sulfide resin (A). When the amount of the carbon black (C) is more than 1.8 parts by weight, the laser marking property is not effectively enhanced. The amount of the carbon black (C) is preferably 1.5 parts by weight or less and more preferably 1.2 parts by weight or less based on 100 parts by weight of the polyphenylene sulfide resin (A).

(D) Oxygen-Deficient Bismuth Oxide

Oxygen-deficient bismuth oxide (D) employed in the present invention is preferably represented by the following formula:

Bi₂O₍₃₋ₓ₎,

where 0.01≤x≤0.3, x represents the amount of oxygen vacancies. X is more preferably 0.01 or more and 0.2 or less, further preferably 0.01 or more and 0.1 or less. X can be 0.02 or more and 0.2 or less, preferably 0.03 or more and 0.1 or less, and more preferably 0.04 or more and 0.1 or less.

The oxygen defect amount x in the above formula is a ratio of an area of a peak attributed to is electron of oxygen, which is bounded to bismuth, to an area of a peak attributed to 4f electrons of bismuth obtained by X-ray photoelectron spectroscopy (O1s/Bi4f). More specifically, the oxygen defect amount x is calculated by the following formula (1):

x=3−(O1s/Bi4f)×2 (1).

For example, when the area ratio is 1.35≤O1s/Bi4f≤1.495, oxygen defect amount x results in 0.01≤x≤0.3. When the area ratio is 1.45≤O1s/Bi4f≤1.495, oxygen defect amount x results in 0.01≤x≤0.1.

The (C) oxygen-defective bismuth oxide used in the present invention preferably has an absorptivity of 20 to 80% at a wavelength of 1064 nm calculated by the following formula (2) based on the diffuse reflectance in the UV visible near-infrared reflection spectrum.

Absorptivity=100−Diffuse Reflectance (%) (2)

It is also preferable that the (C) oxygen-defective bismuth oxide has an absorptivity of 20 to 80% at a wavelength of 532 nm calculated by the above formula (2) based on the diffuse reflectance in the UV visible near-infrared reflection spectrum.

For example, the oxygen-deficient bismuth oxide (D) used in the present invention can be obtained by mixing bismuth oxide and/or a bismuth compound which becomes a bismuth oxide when heat is applied, with metallic aluminum at the ratio of the former (e.g., bismuth oxide) to the latter (Al) of 0.001% to 20% by weight at dry or wet condition, and heating the resulting mixture at 60 to 400° C. under a reduced pressure (e.g., 0.05 MPa or more below the atmospheric pressure (0.101 MPa)).

An amount of the oxygen-deficient bismuth oxide (D) to be added is 0.15 to 0.55 parts by weight based on 100 parts by weight of the polyphenylene sulfide resin (A). When the amount of the oxygen-deficient bismuth oxide (D) is less than 0.15 parts by weight, the laser marking property is not effectively enhanced. The amount of the oxygen-deficient bismuth oxide (D) is preferably 0.2 parts or more by weight based on 100 parts by weight of the polyphenylene sulfide resin (A). When the amount of the oxygen-deficient bismuth oxide (D) is more than 0.55 parts by weight, an amount of gas generated during molding or processing the resin composition increases and the laser marking property is not effectively enhanced. The amount of oxygen-deficient bismuth oxide (D) is preferably 0.4 parts by weight or less based on 100 parts by weight of the polyphenylene sulfide resin (A).

(E) Inorganic Filler

Although there is no limitation on the inorganic filler usable in this invention, glass fiber can be preferably used in the resin composition of the present invention. The inorganic filler that can be used is not limited to glass fiber, and any filler such as fibrous, plate-shaped, powdery or granular filler can be used alone or in combination. For example, the inorganic filler usable in this invention includes carbon fiber such as PAN-based carbon fiber and pitch-based carbon fiber; metal fibers such as stainless steel fibers, aluminum fibers, and brass fibers; organic fibers such as aromatic polyamide fibers; fibrous substances or whiskers such as gypsum fibers, ceramic fibers, asbestos fibers, zirconia fibers, alumina fibers, silica fibers, titanium oxide fibers, silicon carbide fibers, rock wool, potassium titanate whiskers, barium titanate whiskers, aluminum borate whiskers, and silicon nitride whiskers. Further, the inorganic filler usable in this invention includes powdery, granular or plate-like fillers such as mica, talc, kaolin, silica, calcium carbonate, glass flakes, glass beads, glass microballoons, clay, molybdenum disulfide, wollastonite, montmorillonite, titanium oxide, zinc oxide, calcium polyphosphate and graphite. Among them, glass fiber is preferable. The type of glass fiber is not particularly limited a far as it is usable for reinforcing a resin article. For example, chopped strands of long fibers or short fibers, milled fiber or the like can be used in this invention.

Although there is no limitation about the cross-sectional shape of the glass fiber used for this invention, for example, the cross-sectional shape of round shape, flat shape, eyebrows shape, oval shape, elliptical shape, semicircle, or circular arc shape, a rectangle, or these similar shapes can be used.

The fiber diameter of the glass fiber having a round cross-sectional shape according to the present invention (hereinafter sometimes abbreviated as a round glass fiber) is preferably 4 μm to 25 more preferably 6 μm to 20

In the present invention, the glass fiber is preferably opened in the polyphenylene sulfide resin composition. Here, the opened state means a state in which the glass fiber in the polyphenylene sulfide resin composition is opened to a single fiber. Specifically, it means the state in which the number of reinforcing fibers in a bundle of 10 or more is 40% or less of the total number of reinforcing fibers when observed.

The glass fiber used in the present invention is preferably treated with a sizing agent or a surface treatment agent. Examples of the sizing agent or surface treatment agent include functional compounds such as epoxy compounds, isocyanate compounds, silane compounds, and titanate compounds. Epoxy compounds having a high epoxy content are particularly preferred from the viewpoint of improving the heat and moisture resistance of the reinforcing fibers.

The glass fiber of the present invention having a round cross-sectional shape can be obtained, for example, from Nippon Electric Glass Co., Ltd. © under the trade name T-760H.

The mixing amount of the (D) inorganic filler used in the present invention is in the range of 10 to 50 parts by weight with respect to 100 parts by weight of the (A) polyphenylene sulfide resin. If the mixing amount of the (D) inorganic filler (e.g., glass fiber) is less than 10 parts by weight, the strength of an extrusion molded product will fall. Thus, 10 parts by weight or more is preferable, 13 parts by weight or more is more preferable and 15 parts by weight or more is even more preferable. If the mixing amount of the (D) inorganic filler is more than 50 parts by weight, the amount of gas generated during process increases. Thus, 50 parts by weight or less is preferable, 30 parts by weight or less is more preferable, and 20 parts by weight or less is even more preferable.

In the polyphenylene sulfide resin composition in the present invention, other components can be added within the range not impairing the effects of the present invention. Other components include: heat stabilizer agents (hindered phenol series, hydroquinone series, phosphite series and substituted products thereof), weathering agents (resorcinol series, salicylate series, benzotriazole series, benzophenone series, hindered amine series, etc.), release agents and lubricants (montanic acid and its metal salts, its esters, its half esters, stearyl alcohol, stearamide, various bisamides, and bisureas etc.), pigments (cadmium sulfide, phthalocyanine, carbon black for coloring, etc.), dyes (nigrosine, etc.), plasticizers (octyl p-oxybenzoate, N-butylbenzenesulfonamide, etc.), antistatic agents (alkyl sulfate anions antistatic agent, grade 4 ammonium salt type cationic antistatic agent, nonionic antistatic agents such as polyoxyethylene sorbitan monostearate, and betaine amphoteric antistatic agent, etc.), flame retardants (for example, red phosphorus, phosphate ester, melamine cyanurate, hydroxides such as magnesium hydroxide and aluminum hydroxide, ammonium polyphosphate, brominated polystyrene, brominated polyphenylene ether, brominated polycarbonate, brominated epoxy resins or combinations of these brominated flame retardants with antimony trioxide), and other polymers (for example, amorphous resins such as polyamideimide, polyarylate, polyethersulfone, polysulfone, polyphenylene ether, etc.)

In the polyphenylene sulfide resin composition of the present invention, it is preferable that the components (A) to (E) and other components mixed as necessary are uniformly dispersed. As a method for producing the polyphenylene sulfide resin composition of the present invention, for example, a method of melt kneading each component using a known melt kneader such as a single or twin screw extruder, a Banbury mixer, a kneader, or a mixing roll, can be used. Each component may be mixed in advance and then melt kneaded.

In addition, as a method of charging each component into the melt-kneader, for example, using a single-screw or twin-screw extruder, the above (A), (B), (C) and (D) components are supplied from the main charging port installed on the screw base side, (E) inorganic filler is supplied from a sub input port installed between the main input port and the tip of the extruder, and melt-mixed.

The melt kneading temperature is preferably 220° C. or higher, and more preferably 280° C. or higher, in terms of excellent fluidity and mechanical properties. Moreover, 400° C. or less is preferable and 360° C. or less is more preferable. Here, the melt kneading temperature refers to the set temperature of the melt kneader, and refers to the cylinder temperature in the case of a twin screw extruder, for example.

The PPS resin composition obtained in this manner is suitable for extrusion molding applications, and is suitable for extrusion molding products having an average outer diameter of 50 mm or more by virtue of processability during extrusion and the small amount of generated gas.

Since the PPS resin composition in the present invention is excellent in laser marking properties, it is useful in a wide range of applications such as electronic devices, automobile parts, structural parts, mechanical parts, and transportation parts, which require traceability.

Laser Marking Laser marking is performed by irradiating the molded product of the polyrenylene sulfide resin composition with a laser beam to melt, delaminate, oxidize, carbonize, or discolor a surface portion or layer of the molded product. When the laser marking is performed on the molded product of the polyrenylene sulfide resin composition, laser light is scanned, traced and/or irradiated on the surface of the molded product so as to draw a character or figure to be marked.

For example, Nd: YAG laser and Nd: YVO4 laser can be used as the laser in the present invention. In the laser marking, the irradiation conditions of laser light are not particularly limited. For example, the irradiation conditions of laser may be appropriately adjusted depending on materials contained in the target molded article and the heat resistance of the resin composition, so that intended marks or barcodes, etc. can be formed on the surface of the molded product. If the amount of heat generated by laser beam irradiation becomes too large, the visibility of the laser markings will be deteriorated due to carbonization and discoloration of the resin. Thus, it is preferable to adjust the amount of irradiation energy of the laser beam to avoid such a situation. For example, the amount of energy of laser beam can be adjusted by mainly changing the output of laser light, irradiation time (scan speed), and frequency. Since the amount of irradiation energy can be changed by setting the irradiation device, those skilled in the art should be able to find appropriate conditions by conducting some trials changing these combinations while considering the specifications of the device to be used.

### EXAMPLES

Hereinafter, the present invention will be described more specifically with reference to embodiments. However, the present invention is not limited to the description of these embodiments.

### Measuring Method

(1) Amount of Chloroform Extracted from PPS Resin

Using a Soxhlet extractor, extract about 10 g of a PPS sample and 200 ml of chloroform for 5 hours, dry the extract at 50° C., and obtain the residue. Calculate resulting residue divided by the amount of PPS sample charged, and multiply by 100 to express the extracted amount in a percentage.

(2) PPS Resin Melt Flow Rate (MFR)

The measurement temperature was 315.5° C. with 5000 g load, and the measurement was performed by a method according to ASTM-D1238-70.

(3) Difference ΔE in Color Tones

An injection molding machine (J85-AD-110H produced by JAW) was used to mold square plates of 60 mm×60 mm×2 mm at a cylinder temperature of 320° C. and a mold temperature of 140° C. Laser marking was performed at the center portion (10 mm×10 mm) on each of the molded square plates at an output of 60% and a scanning speed of 5000 mm/s by using a FAYb laser marker LP-S200 manufactured by Panasonic Corporation. Then, the color tones of the marked portions and the non-marked portions on the square plates were measured based on JIS Z28722, and the color tone difference ΔE was calculated based on JIS Z8730.

Raw Materials Used

(A) Polymerization of PPS

In a 70 liter autoclave equipped with a stirrer, 8.27 kg (70.00 mol) of 47.5% sodium hydrosulfide, 2.94 kg (70.63 mol) of 96% sodium hydroxide, 11.45 kg (115.50 mol) of N-methyl-2-pyrrolidone (NMP), 1.89 kg (23.1 mol) of sodium acetate, and 5.50 kg of ion-exchanged water, are charged and gradually heated to 245° C. over about 3 hours under nitrogen at normal pressure. After distilling out 9.77 kg of water and 0.28 kg of NMP, the reaction vessel was cooled to 200° C. The residual water content in the system per 1 mol of the charged alkali metal sulfide was 1.06 mol including the water consumed for the hydrolysis of NMP. The amount of hydrogen sulfide scattered was 0.02 mol per 1 mol of the alkali metal sulfide charged.

Thereafter, the mixture was cooled to 200° C., 10.42 kg (70.86 mol) of p-dichlorobenzene and 9.37 kg (94.50 mol) of NMP were added, the reaction vessel was sealed under nitrogen gas, heated from 200° C. to 270° C. at a rate of 6° C./min., and then reacted at 270° C. for 140 minutes. Thereafter, 2.40 kg (133 mol) of water was injected while cooling from 270° C. to 250° C. over 15 min. Next, the mixture was gradually cooled from 250° C. to 220° C. over 75 minutes, and then rapidly cooled to near room temperature, and the contents were taken out.

The contents were diluted with about 35 liters of NMP, stirred as a slurry at 85° C. for 30 minutes, and then filtered through an 80 mesh wire mesh (aperture 0.175 mm) to obtain a solid material. The obtained solid material was similarly washed and filtered with about 35 liters of NMP. The operation of diluting the obtained solid material with 70 liters of ion-exchanged water, stirring at 70° C. for 30 minutes, and filtering through an 80 mesh wire net to recover the solid material, was repeated a total of 3 times.

The obtained solid material and 32 g of acetic acid were diluted with 70 liters of ion exchange water, stirred at 70° C. for 30 minutes, then filtered through an 80 mesh wire net, and further obtained solid material was diluted with 70 liters of ion exchange water, stirred at 70° C. for 30 minutes, and then filtered through an 80 mesh wire net to recover a solid material. The solid material thus obtained was dried at 120° C. under a nitrogen stream to obtain dry PPS. The obtained PPS had melt flow rate (MFR) of 300 g/10 min.

(B) Thermoplastic resin having a melting point of 200° C. or less in accordance with ISO 11357

(B-1): Nylon 66 (Vydyne 21Z manufactured by Ascend)

(B-2); Nylon 6 (H35 manufactured by AdvanSix)

(B-3): Polybutylene terephthalate (PBT)(“Toraycon” 11005 manufactured by Toray Industries, Inc.)

(B-4): Polyethylene terephthalate (PET) (Mitsui PET:1005 manufactured by Mitsui Pet Resin Co., Ltd.)

(B-5): Polycarbonate (PC) (Idemitsu Kosan Co., Ltd. “Taflon” A1900)

(C) Carbon black (Black Pearls 900 manufactured by CABOT)

(D) Oxygen-deficient bismuth oxide (TOMATEC 42-920A)

(E) Glass fiber (T-760H manufactured by Nippon Electric Glass Co., Ltd., 3 mm long, average fiber diameter 10.5 μm).

### Examples 1 to 12

As shown in Table 1, the composition of the resin composition was changed. The components (A), (B), (C), and (D) were supplied from the main charging port of the twin-screw extruder, the component (E) was supplied from the sub input port installed between the main input port and the tip of the extruder, the mixture was melt-kneaded with a twin-screw extruder having a screw diameter of 26 mm at a cylinder temperature set at 300° C. Then the mixture was pelletized by a strand cutter. Molding and evaluation were performed using pellets dried overnight at 120° C.

TABLE 1

| PPS Resin | | | | | | | | | | | | |
|---|---|---|---|---|---|---|---|---|---|---|---|---|
| Composition | Examples | | | | | | | | | | | |
| (parts by wt.) | 1 | 2 | 3 | 4 | 5 | 6 | 7 | 8 | 9 | 10 | 11 | 12 |
| (A) PPS | 100 | 100 | 100 | 100 | 100 | 100 | 100 | 100 | 100 | 100 | 100 | 100 |
| (B-1) Nylon 66 | 1.8 | | | | | 0.9 | 3.5 | 1.8 | 1.8 | 1.8 | 1.8 | 1.8 |
| (B-2) Nylon 6 | | 1.8 | | | | | | | | | | |
| (B-3) PBT | | | 1.8 | | | | | | | | | |
| (B-4) PET | | | | 1.8 | | | | | | | | |
| (B-5) PC | | | | | 1.8 | | | | | | | |
| (C) Carbon Black | 0.9 | 0.9 | 0.9 | 0.9 | 0.9 | 0.9 | 0.9 | 0.55 | 1.6 | 0.9 | 0.9 | 0.9 |
| (D) Bismuth oxide | 0.35 | 0.35 | 0.35 | 0.35 | 0.35 | 0.35 | 0.35 | 0.35 | 0.35 | 0.2 | 0.5 | 0.35 |
| (E) Glass fiber | 71 | 71 | 71 | 71 | 71 | 71 | 71 | 71 | 71 | 71 | 71 | 0 |
| ΔE in Color Tones | 6.7 | 6.9 | 6.4 | 6.3 | 6.4 | 5.2 | 5.1 | 4.6 | 4.5 | 6.3 | 6.4 | 6.0 |

### Comparative Examples 1 to 6

As shown in Table 2, the composition of the resin composition was changed. The components (A), (B), (C), and (D) were supplied from the main charging port of the twin-screw extruder, the component (E) was supplied from the sub input port installed between the main input port and the tip of the extruder, the mixture was melt-kneaded with a twin-screw extruder having a screw diameter of 26 mm at a cylinder temperature set at 300° C. Then the mixture was pelletized by a strand cutter. Molding and evaluation were performed using pellets dried overnight at 120° C. In any case, the color tone difference ΔE was inferior.

TABLE 2

| PPS Resin | | | | | | |
|---|---|---|---|---|---|---|
| Composition | Comparative Examples | | | | | |
| (parts by wt.) | 1 | 2 | 3 | 4 | 5 | 6 |
| (A) PPS | 100 | 100 | 100 | 100 | 100 | 100 |
| (B-1) Nylon 66 | | 5 | 1.8 | 1.8 | 1.8 | 1.8 |
| (B-2) Nylon 6 | | | | | | |
| (B-3) PBT | | | | | | |
| (B-4) PET | | | | | | |
| (B-5) PC | | | | | | |
| (C) Carbon Black | 0.9 | 0.9 | 0.2 | 2 | 0.9 | 0.9 |
| (D) Bismuth oxide | 0.35 | 0.35 | 0.35 | 0.35 | | 1 |
| (E) Glass fiber | 71 | 71 | 71 | 71 | 71 | 71 |
| ΔE in Color Tones | 4.2 | 3.8 | 3.6 | 3.7 | 4.3 | 4.2 |

According to the present invention, properties for laser marking of polyphenylene sulfide composition are significantly improved. For example, productivity (e.g., marking speed) of applying laser marking to polyphenylene sulfide resin articles is improved. Further, by improving the readability of barcodes, QR codes, etc., it becomes possible to apply laser marking to a wide range of fields such as electronic devices, automobile parts, structural parts, mechanical parts, transportation parts, etc. where traceability is required.

1. A polyphenylene sulfide resin composition comprising:
(A) a polyphenylene sulfide resin;
(B) a thermoplastic resin having a melting point of 200° C. or less in accordance with ISO 11357 in an amount of 0.5 to 4.0 parts by weight based on 100 parts by weight of the polyphenylene sulfide resin (A);
(C) a carbon black in an amount of 0.5 to 1.8 parts by weight based on 100 parts by weight of the polyphenylene sulfide resin (A); and
(D) oxygen-deficient bismuth oxide represented by the following formula in an amount of 0.15 to 0.55 parts by weight based on 100 parts by weigh of the polyphenylene sulfide resin (A):
Bi₂O₍₃₋ₓ₎,
wherein x is 0.01≤x≤0.3, and represents the amount of oxygen vacancy defined by the following formula (1):
x=3−(O1s/Bi4f)×2 (1)
wherein O1s represents an area of a peak attributed to is electron of oxygen bound to bismuth and Bi4f represents an area of a peak attributed to 4f electrons of bismuth obtained by X-ray photoelectron spectroscopy, respectively, and (O1s/Bi4f) represents a ratio of the area of O1s to the area of Bi4f.

2. The polyphenylene sulfide resin composition according to claim 1, wherein
(B) the thermoplastic resin comprises at least one resin selected from the group consisting of a polyester resin, a polyamide resin, and a polycarbonate resin.

3. The polyphenylene sulfide resin composition according to claim 1, wherein
(B) the thermoplastic resin is a polyamide resin.

4. The polyphenylene sulfide resin composition according to claim 1, wherein
the amount of the carbon black (C) is 0.7 to 1.2 parts by weight based on 100 parts by weight of the polyphenylene sulfide resin (A).

5. The polyphenylene sulfide resin composition according to claim 1, further comprising (E) an inorganic filler in an amount of 10 to 150 parts by weight based on 100 parts by weight of the polyphenylene sulfide resin (A).

6. The polyphenylene sulfide resin composition according to claim 5, wherein
the inorganic filler (E) is glass fiber.
